(19) United States
(12) Patent Application Publication
(10) Pub. No.: US 2013/0288715 A1
(43) Pub. Date: Oct. 31, 2013

(54) CONTENT DELIVERY SYSTEM WITH CONTENT DISPLAY MECHANISM AND METHOD OF OPERATION THEREOF

(71) Applicants: Eddie Shieh, San Francisco, CA (US); Tom Brinck, Palo Alto, CA (US)

(72) Inventors: Eddie Shieh, San Francisco, CA (US); Tom Brinck, Palo Alto, CA (US)

(73) Assignee: SAMSUNG ELECTRONICS CO., LTD., Gyeonggi-Do (KR)

(21) Appl. No.: 13/460,601

(22) Filed: Apr. 30, 2012

(51) Int. Cl. H04W 4/02

(52) U.S. Cl. 455/456.3

(57) ABSTRACT

A method of operation of a content delivery system includes: detecting a target user's location for identifying the target user's location within a venue; determining a target user's status based on the target user's location for identifying the target user's status within the venue; generating a target user's content based on the target user's status; and generating a public content based on the target user's status, the public content different from the target user's content, for displaying on a device within the venue.

### TECHNICAL FIELD

The present invention relates generally to a content delivery system, and more particularly to a system for content display mechanism.

### BACKGROUND ART

Modern portable consumer and industrial electronics, especially client devices such as navigation systems, cellular phones, portable digital assistants, and combination devices, are providing increasing levels of functionality to support modern life including personalized content services. Research and development in the existing technologies can take a myriad of different directions.

As users become more empowered with the growth of personalized content service devices, new and old paradigms begin to take advantage of this new device space. There are many technological solutions to take advantage of this new device location opportunity. One existing approach is to evaluate user profile and location information to provide personalized content through a mobile device such as a cell phone, a smart phone, or a personal digital assistant.

Personalized content services allow users to create, transfer, store, and/or consume information in order for users to create, transfer, store, and consume in the “real world.” One such use of personalized content services is to efficiently transfer or guide users to the desired product or service.

Content delivery system and personalized content enabled systems have been incorporated in automobiles, notebooks, handheld devices, and other portable products. Today, these systems aid users by incorporating available, real-time relevant information, such as advertisement, entertainment, local businesses, or other points of interest (POI).

However, a content delivery system with a content display mechanism has become a paramount concern for the consumer. The inability decreases the benefit of using the tool.

Thus, a need still remains for a content delivery system with a content display mechanism. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a content delivery system including: detecting a target user's location for identifying the target user's location within a venue; determining a target user's status based on the target user's location for identifying the target user's status within the venue; generating a target user's content based on the target user's status; and generating a public content based on the target user's status, the public content different from the target user's content, for displaying on a device within the venue.

The present invention provides a content delivery system including: a detector module for detecting a target user's location within a venue; a status module, coupled to the detector module, for determining a target user's status based on the target user's location for identifying the target user's status within the venue; a public information module, coupled to the status module, for generating a target user's content based on the target user's status; and a public information module, coupled to the personal information module, for generating a public content based on the target user's status, the public content different from the target user's content, for displaying on a device within the venue.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a content delivery system with content display mechanism in an embodiment of the present invention.

FIG. 2 is an example of detecting a target user's location for the target user of the first device of FIG. 1 within a venue.

FIG. 3 is an example of the target user's location outside of the venue.

FIG. 4 is an example of a display of the target user's content with a benefit preview.

FIG. 5 is an example of a display of the venue co-participant's content influenced by a presence of the target user's location within the venue.

FIG. 6 is an example of a display of the public content displayed on the public device of FIG. 2.

FIG. 7 is an example of a display of the service content displayed on the service device.

FIG. 8 is an exemplary block diagram of the content delivery system.

FIG. 9 is a control flow of the content delivery system.

FIG. 10 is a flow chart of a method of operation of the content delivery system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention. Where multiple embodiments are disclosed and described having some features in common, for clarity and ease of illustration, description, and comprehension thereof, similar and like features one to another will ordinarily be described with similar reference numerals.

The term “user experience” encompasses a user's perceptions of the practical aspects such as utility, ease of use, and efficiency of the present invention. The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

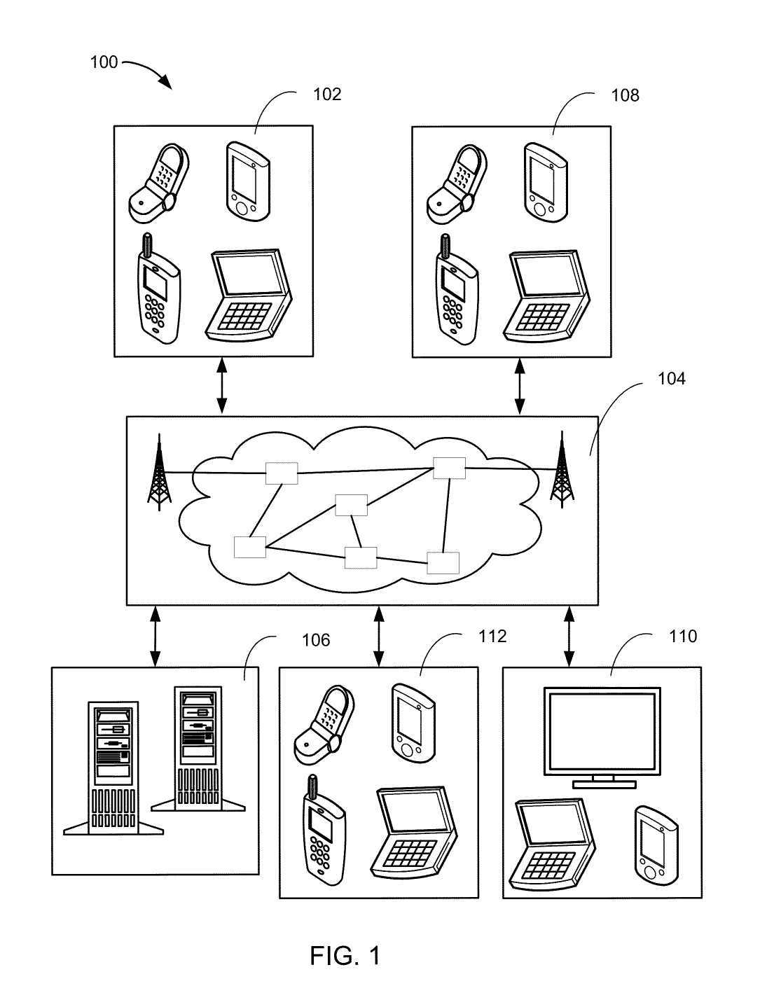

Referring now to FIG. 1, therein is shown a content delivery system 100 with content display mechanism in an embodiment of the present invention. The content delivery system 100 includes a first device 102, such as a client or a server, connected to a second device 106, such as a client or server, with a communication path 104, such as a wireless or wired network. The content delivery system 100 can also include a third device 108, a fourth device 110, and a fifth device 112 connected to the second device 106 with the communication path 104. The third device 108, the fourth device 110, and the fifth device 112 can be a client or server.

For example, the first device 102, the third device 108, the fourth device 110, or the fifth device 112 can be of any of a variety of mobile devices, such as a cellular phone, personal digital assistant, a notebook computer, automotive telematic navigation system, or other multi-functional mobile communication or entertainment device. The first device 102, the third device 108, the fourth device 110, or the fifth device 112 can be a standalone device, or can be incorporated with a vehicle, for example a car, truck, bus, or train. The first device 102, the third device 108, the fourth device 110, and the fifth device 112 can couple to the communication path 104 to communicate with the second device 106.

For illustrative purposes, the content delivery system 100 is described with the first device 102 and the third device 108 as a mobile computing device, although it is understood that the first device 102 and the third device 108 can be different types of computing devices. For example, the first device 102 and the third device 108 can also be a non-mobile computing device, such as a server, a server farm, or a desktop computer. The fourth device 110 and the fifth device 112 can be a non-mobile computing device, such as a desktop computer, a large format display (LFD), or a computer terminal.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102 or the third device 108. The second device 106 can also be a client type device as described for the first device 102.

In another example, the first device 102 and the third device 108 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106, the fourth device 110, and the fifth device 112 can be a particularized machine, such as a portable computing device, a thin client, a notebook, a netbook, a smartphone, personal digital assistant, or a cellular phone, and as specific examples, an Apple iPhone™, Palm Centro™, Samsung Galaxy™, or Moto Q Global™.

For illustrative purposes, the content delivery system 100 is described with the second device 106, the fourth device 110, and the fifth device 112 as a non-mobile computing device, although it is understood that the second device 106 can be different types of computing devices. For example, the second device 106, the fourth device 110, and the fifth device 112 can also be a mobile computing device, such as notebook computer, another client device, or a different type of client device.

Also for illustrative purposes, the content delivery system 100 is shown with the second device 106, the first device 102, the third device 108, the fourth device 110, and the fifth device 112 as end points of the communication path 104, although it is understood that the content delivery system 100 can have a different partition between the first device 102, the second device 106, the third device 108, the fourth device 110, the fifth device 112, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), near field communication (NFC), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

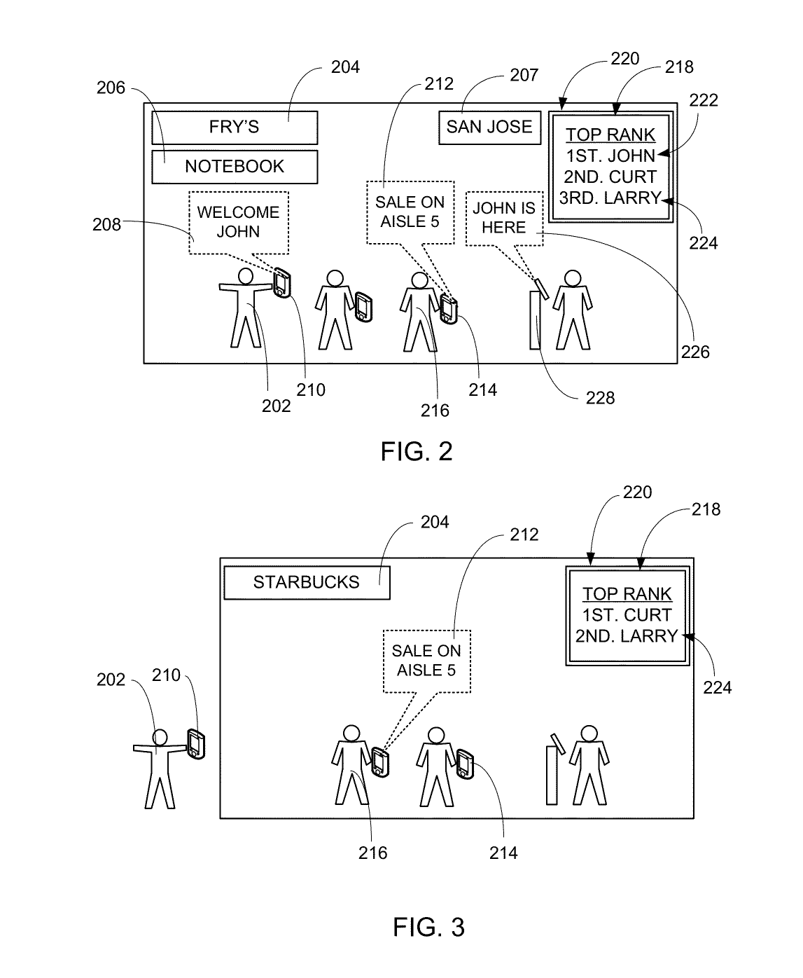

Referring now to FIG. 2, therein is shown an example of detecting a target user's location 202 for the target user of the first device 102 of FIG. 1 within a venue 204. The target user is defined as the user of the first device 102 who can receive the output generated by the content delivery system 100 of FIG. 1 to the first device 102.

The target user's location 202 is defined as the geographic location of the target user of the first device 102. The venue 204 is defined as the geographic area. For example, the venue 204 can be the geographic area where the benefit of the present invention is available. For further example, the venue 204 can include the geographic area within a grocery store, a sports arena, a shopping mall, or an entertainment facility. For another example, the venue 204 can include a geographic region representing a city. More specifically, a boundary of the venue 204 can represent a borderline of the city.

The venue 204 can include a section 206, which is defined as the subdivision of the venue 204. For example, the venue 204 representing a grocery store can include the section 206 representing the dairy section. For another example, the venue 204 representing a sports arena can include the section 206 representing the Very Important Person (VIP) seating area.

A venue association 207 is defined as a common attribute shared by the venue 204 for grouping a plurality of the venue 204 in a category. For example, the venue association 207 can include a chain of stores, a franchise, a branch, a department, or a type of cuisine. For specific example, Fry's Electronics™ (hereinafter “Fry's”) can have a store in San Jose, Calif. and Fremont, Calif. Both the San Jose store and the Fremont store share the venue association 207 as the branch store of Fry's.

The content delivery system 100 can display a target user's content 208 on a target user's device 210. For example, the target user's device 210 can include the first device 102. For brevity and clarity, the discussion of the present invention will focus on the content delivery system 100 generating the result for the target user to the first device 102. For example, the result generated to the first device 102 or the target user's device 210 can represent the target user's content 208.

The target user's content 208 is defined as the personalized content for the target user when the target user's location 202 is detected within the venue 204. For example, the content delivery system 100 can send a welcome message of “Welcome John” to the target user's device 210 when the target user's location 202 is detected within the venue 204. Details regarding the target user's content 208 will be discussed later.

The content delivery system 100 can display a venue co-participant's content 212 on a venue co-participant's device 214. A venue co-participant is defined as a user other than the target user who can be within the venue 204. For example, the venue co-participant's device 214 can include the third device 108 of FIG. 1. For brevity and clarity, the discussion of the present invention will focus on the content delivery system 100 generating the result for the venue co-participant to the third device 108. For example, the result generated to the third device 108 or the venue co-participant's device 214 can represent the venue co-participant's content 212.

The venue co-participant's content 212 is defined as the personalized content for the venue co-participant when a venue co-participant's location 216 is detected within the venue 204. The venue co-participant's location 216 is defined as the geographic location of the venue co-participant. For example, the content delivery system 100 can send a notification for a daily special of “Sale on aisle 5” to the venue co-participant's device 214 when the venue co-participant's location 216 is detected within the venue 204. Details regarding the venue co-participant's content 212 will be discussed later.

The content delivery system 100 can display a public content 218 on a public device 220. The public device 220 is defined as a device installed within the venue 204 for displaying the result generated by the content delivery system 100 to all persons or the public within the venue 204. For example, the public device 220 can include the fourth device 110 of FIG. 1. For brevity and clarity, the discussion of the present invention will focus on the content delivery system 100 generating the result for the public to the fourth device 110. For example, the result generated to the fourth device 110 or the public device 220 can represent the public content 218. For further example, the public device 220 can include a signage display, an electronic billboard, an electronic bulletin board, or an LFD.

The public content 218 is defined as the information, generated by the content delivery system 100, made available to all people within the venue 204. For example, the public content 218 can include a target user's status 222, a venue co-participant's status 224, sales information, or a combination thereof.

The target user's status 222 is defined as the level of merit achieved by the target user. For example, the target user's status 222 can represent the level of merit achieved by the target user in relation to the venue co-participant within the venue 204. For different example, the target user's status 222 can represent the level of merit achieved by the target user for a service offered within the venue 204.

For specific example, the target user can improve the target user's status 222 within the venue 204 by collecting reward points, scores, medals, trophies, levels, tokens, ranks, or a combination thereof. For example, the venue 204 can be Fry's. Fry's can offer reward points for all shoppers that spend over $10 U.S. dollar (USD). Fry's can also rank the shopper based on the amount of reward points collected. The target user can improve the target user's status 222 at Fry's if the target user spends more than $10 USD at Fry's.

The venue co-participant's status 224 is defined as the level of merit achieved by the venue co-participant. For example, the venue co-participant's status 224 can represent the level of merit achieved by the venue co-participant in relation to the target user or a different venue co-participant within the venue 204. For different example, the venue co-participant's status 224 can represent the level of merit achieved by the venue co-participant for a service offered within the venue 204.

For specific example, if the target user collected the most reward points at Fry's, the venue co-participant's status 224 will be lower ranked than the target user's status 222. As discussed previously, the public content 218 can include the ranking of the target user's status 222 relative to the venue co-participant's status 224 displayed on the public device 220 within the venue 204.

For another example, the public content 218 can include the ranking between different branches of the venue 204 sharing the venue association 207. The venue 204 can represent Starbucks™ in San Jose, Calif. and Seattle, Wash. The San Jose shop and the Seattle shop can share the venue association 207 of being a branch store for Starbucks™. The target user can be a top rank at the Starbucks™ San Jose. When the target user visits the Starbucks™ Seattle, the public content 218 can include the target user's ranking for San Jose and the target user's ranking relative to the ranking for Starbucks™ Seattle branch.

The content delivery system 100 can display a service content 226 on a service device 228. The service device 228 is defined as the device used by an official representative of the venue 204. The official representative can include an employee working at the venue 204.

For example, the service device 228 can include the fifth device 112 of FIG. 1. For brevity and clarity, the discussion of the present invention will focus on the content delivery system 100 generating the result for the official representative to the fifth device 112. For example, the result generated to the fifth device 112 or the service device 228 can represent the service content 226. For specific example, the service device 228 can represent a computer terminal that can function as a cash register for the employee of Fry's. Further, the service device 228 is not available to the public and only the official representative of Fry's, such as the employee, can access the service device 228.

The service content 226 is defined as the information, generated by the content delivery system 100, made available to the official representative of the venue 204. For example, the service content 226 can include a target user's profile. More specifically, the target user's profile can include the target user's status 222, an activity history, or a combination thereof. The activity history can include activities within the venue 204, such as making a purchase at the venue 204, being a member of the venue 204, or providing rating or feedbacks for the product, service, or a combination thereof offered at the venue 204. Details regarding the service content 226 will be discussed later.

Referring now to FIG. 3, therein is shown an example of the target user's location 202 outside of the venue 204. For example, the content delivery system 100 of FIG. 1 is not detecting the target user's location 202 within the venue 204 because the target user's location 202 is outside of the venue 204. As a result, the content delivery system 100 has not delivered the target user's content 208 of FIG. 2 to the target user's device 210. Further, the public device 220 does not display the public content 218 with information related to the target user, such as the target user's status 222 of FIG. 2, because the content delivery system 100 did not detect the target user's location 202 within the venue 204.

Instead, the content delivery system 100 can detect the venue co-participant's location 216 within the venue 204. Subsequently, the content delivery system 100 can generate the venue co-participant's content 212 for displaying on the venue co-participant's device 214. Further, the public device 220 can display the public content 218 with information related venue co-participant, such as the venue co-participant's status 224.

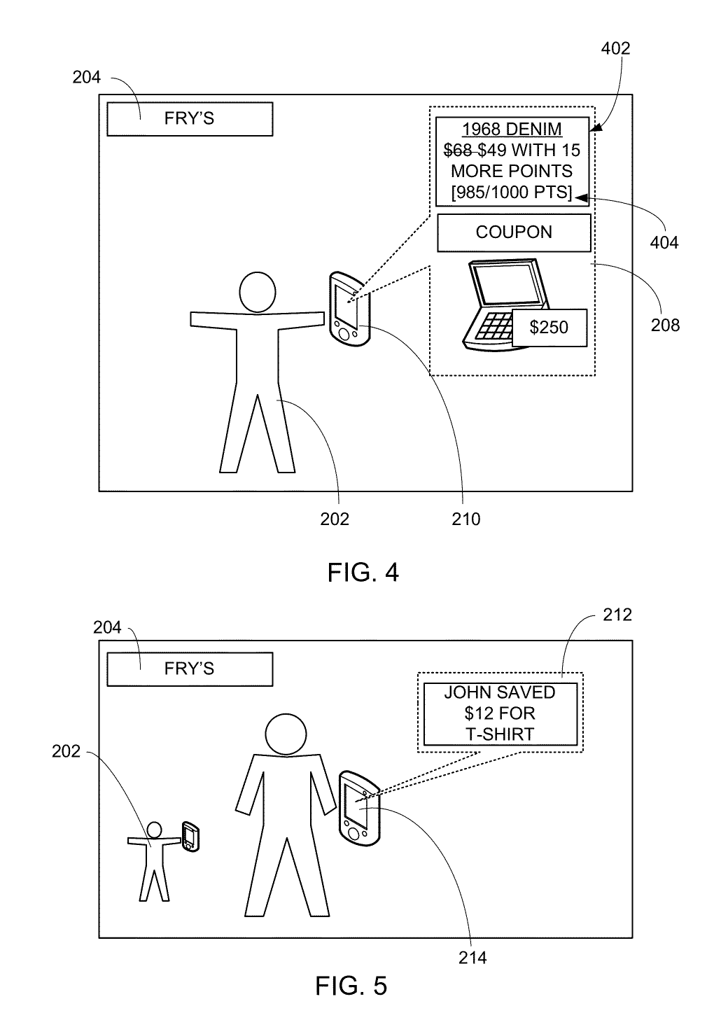

Referring now to FIG. 4, therein is shown an example of a display of the target user's content 208 with a benefit preview 402. For example, if the target user's location 202 is detected within the venue 204, the content delivery system 100 of FIG. 1 can deliver the target user's content 208 to the target user's device 210. For specific example, the target user's content 208 can include an image of a product available within the venue 204 with an overlay of a price of the product as an augmented reality. For another example, the target user's content 208 can include a coupon to purchase the product in the venue 204.

The benefit preview 402 is defined as an advance showing of the benefit offered at the venue 204. For example, the target user can take advantage within the venue 204 after meeting or exceeding a benefit threshold 404. The benefit threshold 404 is defined as a minimum amount of reward points, scores, or a combination thereof required by a participant to take advantage of the benefit offered by the venue 204. For example, the benefit available within the venue 204 can include a discount for making a purchase, an access of service or product within the venue 204, notoriety within the venue 204, or a combination thereof. For specific example, as discussed previously, the target user can accumulate the reward points shopping at the venue 204 representing Fry's. As shown in FIG. 4, the target user can fall short, by 15 reward points, from taking advantage of the discount for purchasing denim jeans with at a discount price. The target user's content 208 can include the benefit preview 402 to show the future benefit that the target user can reap at the venue 204. The benefit preview 402 can be displayed on the target user's device 210, the venue co-participant's device 214 of FIG. 2, the public device 220 of FIG. 2, or a combination thereof.

Referring now to FIG. 5, therein is shown an example of a display of the venue co-participant's content 212 influenced by a presence of the target user's location 202 within the venue 204. For example, the content delivery system 100 of FIG. 1 can track a target user's activity within the venue 204. For specific example, if the target user reaps a benefit from using the reward points within the venue 204, the content delivery system 100 can generate the venue co-participant's content 212 with what target user had benefited. The venue co-participant's content 212 can show that the target user had saved $12USD using reward points displayed on the venue co-participant's device 214.

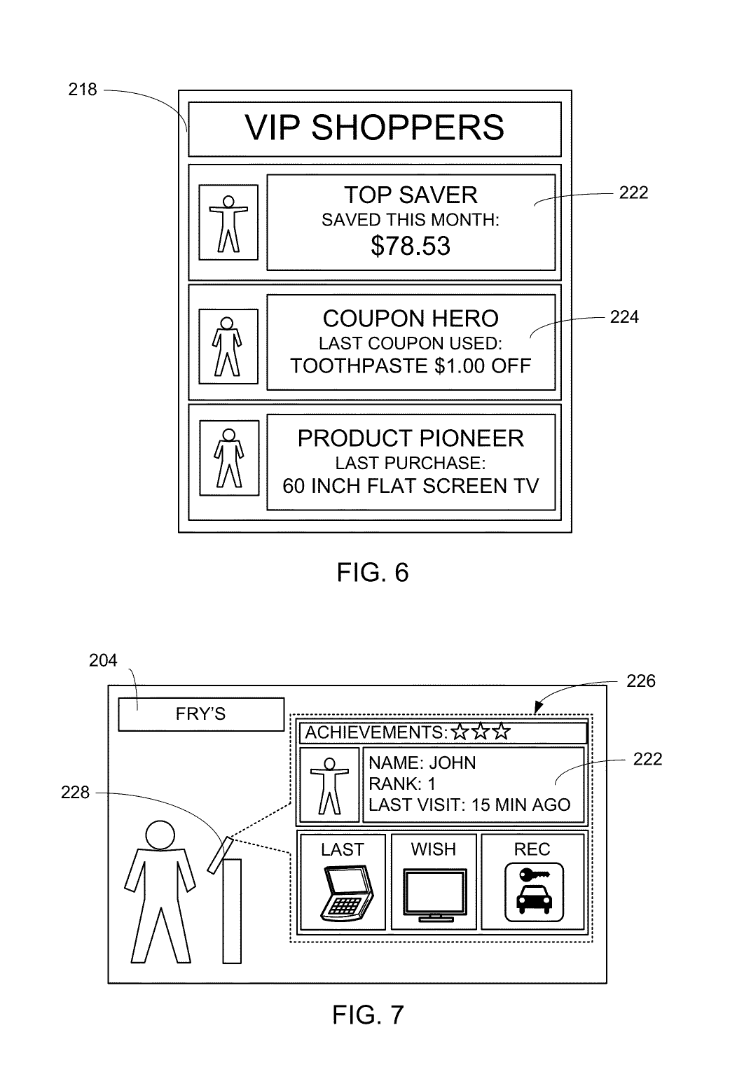

Referring now to FIG. 6, therein is shown an example of a display of the public content 218 displayed on the public device 220 of FIG. 2. As discussed previously, the public content 218 can include the target user's status 222, the venue co-participant's status 224, or a combination thereof. Further, the public content 218 can include the benefit reaped by the target user and the venue co-participant for the activities conducted within the venue 204 of FIG. 2. For further example, the public content 218 can include the benefit threshold 404 of FIG. 4 surpassed by the target user to publicize the target user's achievement within the venue 204.

For different example, the public content 218 can include benefit repeated by a plurality of the venue co-participant within the venue 204. The activities conducted by the target user, the venue co-participant, or a combination thereof can be displayed on the public device 220 to garner interest of other users within the venue 204. Moreover, the public content 218 can include the information to motivate the target user, the venue co-participant, or a combination thereof to increase activities within the venue 204 to take advantage of the benefit offered by the venue 204.

Referring now to FIG. 7, therein is shown an example of a display of the service content 226 displayed on the service device 228. The service content 226 can include the target user's profile. The target user's profile can include the target user's status 222, the target user's activity history, a target user's potential future activity, a recommendation, or a combination thereof.

For example, the target user's activity history can include a target user's past shopping record. For a specific example, the target user can purchase the laptop computer in a previous visit to the venue 204. The target user's activity history can include the target user's rating for the product he purchased, the service he received, or a combination thereof. The target user's potential future activity can include a target user's wish list for possible future purchase. For example, the target user can desire to purchase a 60-inch flat screen television after the target user had accumulated sufficient amount of the reward points to reduce a purchase price for the flat screen television. The recommendation can include a potential product or service desired by the target user if offered by the employees of the venue 204.

The service content 226 can aid the official representative of the venue 204 to provide highly personalized activity experience within the venue 204. The highly personalized activity experience can include improvements on the product, the service, or a combination thereof based on the target user's feedback for his experience at the venue 204. Furthermore, by having the user's activity history readily available at the service device 228, the official representative can tend to the target user's needs and wants accurately and efficiently.

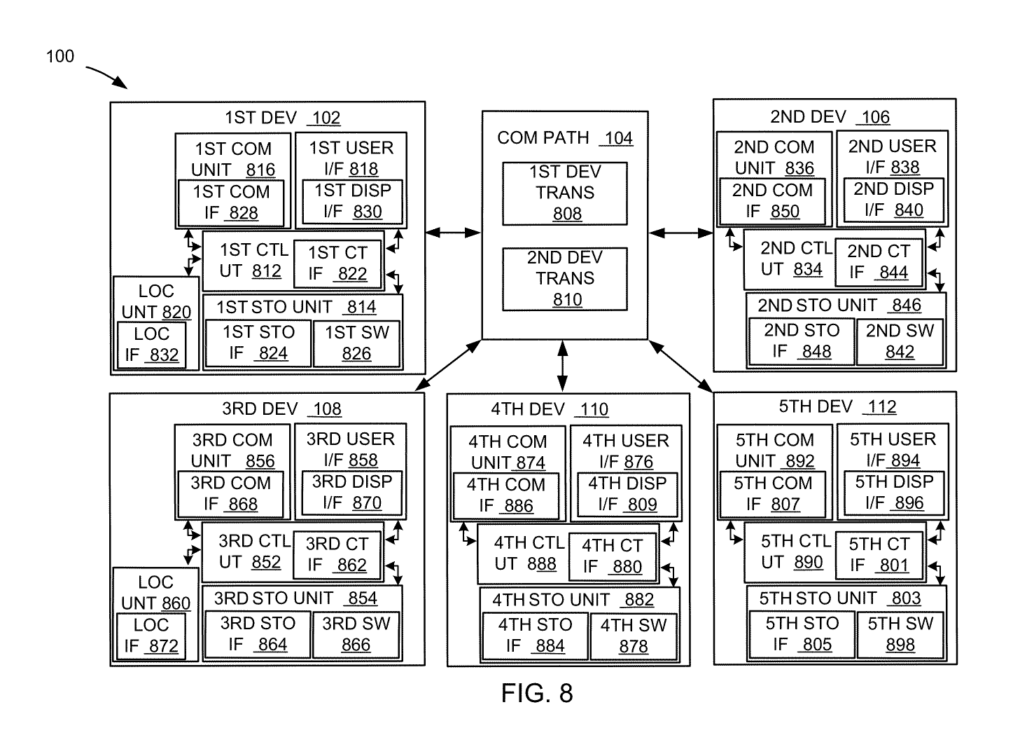

Referring now to FIG. 8, therein is an exemplary block diagram of the content delivery system 100. The content delivery system 100 of FIG. 1 can include the first device 102, the third device 108, the fourth device 110, the fifth device 112, the communication path 104, and the second device 106.

The first device 102, the third device 108, the fourth device 110, or the fifth device 112 can communicate with the second device 106 over the communication path 104. The first device 102 can send information in a first device transmission 808 over the communication path 104 to the second device 106. The second device 106 can send information in a second device transmission 810 over the communication path 104 to the first device 102.

For illustrative purposes, the content delivery system 100 is shown with the first device 102, the third device 108, the fourth device 110, or the fifth device 112 as a client device, although it is understood that the content delivery system 100 can have the first device 102, the third device 108, the fourth device 110, or the fifth device 112 as a different type of device. For example, the first device 102, the third device 108, the fourth device 110, or the fifth device 112 can be a server.

Also for illustrative purposes, the content delivery system 100 is shown with the second device 106 as a server, although it is understood that the content delivery system 100 can have the second device 106 as a different type of device. For example, the second device 106 can be a client device.

For brevity of description in this embodiment of the present invention, the first device 102, the third device 108, the fourth device 110, and the fifth device 112 will be described as a client device and the second device 106 will be described as a server device. The present invention is not limited to this selection for the type of devices. The selection is an example of the present invention.

The first device 102 can include a first control unit 812, a first storage unit 814, a first communication unit 816, a first user interface 818, and a location unit 820. The first control unit 812 can include a first control interface 822. The first control unit 812 can execute a first software 826 to provide the intelligence of the content delivery system 100. The first control unit 812 can be implemented in a number of different manners. For example, the first control unit 812 can be a processor, an embedded processor, a microprocessor, a hardware control logic, a hardware finite state machine (FSM), a digital signal processor (DSP), or a combination thereof. The first control interface 822 can be used for communication between the first control unit 812 and other functional units in the first device 102. The first control interface 822 can also be used for communication that is external to the first device 102.

The first control interface 822 can receive information from the other functional units or from external sources, or can transmit information to the other functional units or to external destinations. The external sources and the external destinations refer to sources and destinations physically separate to the first device 102.

The first control interface 822 can be implemented in different ways and can include different implementations depending on which functional units or external units are being interfaced with the first control interface 822. For example, the first control interface 822 can be implemented with a pressure sensor, an inertial sensor, a microelectromechanical system (MEMS), optical circuitry, waveguides, wireless circuitry, wireline circuitry, or a combination thereof.

The location unit 820 can generate location information, current heading, and current speed of the first device 102, as examples. The location unit 820 can be implemented in many ways. For example, the location unit 820 can function as at least a part of a global positioning system (GPS), an inertial navigation system, a cellular-tower location system, a pressure location system, or any combination thereof.

The location unit 820 can include a location interface 832. The location interface 832 can be used for communication between the location unit 820 and other functional units in the first device 102. The location interface 832 can also be used for communication that is external to the first device 102.

The location interface 832 can receive information from the other functional units or from external sources, or can transmit information to the other functional units or to external destinations. The external sources and the external destinations refer to sources and destinations physically separate to the first device 102.

The location interface 832 can include different implementations depending on which functional units or external units are being interfaced with the location unit 820. The location interface 832 can be implemented with technologies and techniques similar to the implementation of the first control interface 822.

The first storage unit 814 can store the first software 826. The first storage unit 814 can also store the relevant information, such as advertisements, points of interest (POI), navigation routing entries, or any combination thereof.

The first storage unit 814 can be a volatile memory, a nonvolatile memory, an internal memory, an external memory, or a combination thereof. For example, the first storage unit 814 can be a nonvolatile storage such as non-volatile random access memory (NVRAM), Flash memory, disk storage, or a volatile storage such as static random access memory (SRAM).

The first storage unit 814 can include a first storage interface 824. The first storage interface 824 can be used for communication between the location unit 820 and other functional units in the first device 102. The first storage interface 824 can also be used for communication that is external to the first device 102.

The first storage interface 824 can receive information from the other functional units or from external sources, or can transmit information to the other functional units or to external destinations. The external sources and the external destinations refer to sources and destinations physically separate to the first device 102.

The first storage interface 824 can include different implementations depending on which functional units or external units are being interfaced with the first storage unit 814. The first storage interface 824 can be implemented with technologies and techniques similar to the implementation of the first control interface 822.

The first communication unit 816 can enable external communication to and from the first device 102. For example, the first communication unit 816 can permit the first device 102 to communicate with the second device 106 of FIG. 1, an attachment, such as a peripheral device or a computer desktop, and the communication path 104.

The first communication unit 816 can also function as a communication hub allowing the first device 102 to function as part of the communication path 104 and not limited to be an end point or terminal unit to the communication path 104. The first communication unit 816 can include active and passive components, such as microelectronics or an antenna, for interaction with the communication path 104.

The first communication unit 816 can include a first communication interface 828. The first communication interface 828 can be used for communication between the first communication unit 816 and other functional units in the first device 102. The first communication interface 828 can receive information from the other functional units or can transmit information to the other functional units.

The first communication interface 828 can include different implementations depending on which functional units are being interfaced with the first communication unit 816. The first communication interface 828 can be implemented with technologies and techniques similar to the implementation of the first control interface 822.

The first user interface 818 allows a user (not shown) to interface and interact with the first device 102. The first user interface 818 can include an input device and an output device. Examples of the input device of the first user interface 818 can include a keypad, a touchpad, soft-keys, a keyboard, a microphone, or any combination thereof to provide data and communication inputs.

The first user interface 818 can include a first display interface 830. The first display interface 830 can include a display, a projector, a video screen, a speaker, or any combination thereof.

The first control unit 812 can operate the first user interface 818 to display information generated by the content delivery system 100. The first control unit 812 can also execute the first software 826 for the other functions of the content delivery system 100, including receiving location information from the location unit 820. The first control unit 812 can further execute the first software 826 for interaction with the communication path 104 via the first communication unit 816.

The second device 106 can be optimized for implementing the present invention in a multiple device embodiment with the first device 102. The second device 106 can provide the additional or higher performance processing power compared to the first device 102. The second device 106 can include a second control unit 834, a second communication unit 836, and a second user interface 838.

The second user interface 838 allows a user (not shown) to interface and interact with the second device 106. The second user interface 838 can include an input device and an output device. Examples of the input device of the second user interface 838 can include a keypad, a touchpad, soft-keys, a keyboard, a microphone, or any combination thereof to provide data and communication inputs. Examples of the output device of the second user interface 838 can include a second display interface 840. The second display interface 840 can include a display, a projector, a video screen, a speaker, or any combination thereof.

The second control unit 834 can execute a second software 842 to provide the intelligence of the second device 106 of the content delivery system 100. The second software 842 can operate in conjunction with the first software 826. The second control unit 834 can provide additional performance compared to the first control unit 812.

The second control unit 834 can operate the second user interface 838 to display information. The second control unit 834 can also execute the second software 842 for the other functions of the content delivery system 100, including operating the second communication unit 836 to communicate with the first device 102 over the communication path 104.

The second control unit 834 can be implemented in a number of different manners. For example, the second control unit 834 can be a processor, an embedded processor, a microprocessor, a hardware control logic, a hardware finite state machine (FSM), a digital signal processor (DSP), or a combination thereof.

The second control unit 834 can include a second control interface 844. The second control interface 844 can be used for communication between the second control unit 834 and other functional units in the second device 106. The second control interface 844 can also be used for communication that is external to the second device 106.

The second control interface 844 can receive information from the other functional units or from external sources, or can transmit information to the other functional units or to external destinations. The external sources and the external destinations refer to sources and destinations physically separate to the second device 106.

The second control interface 844 can be implemented in different ways and can include different implementations depending on which functional units or external units are being interfaced with the second control interface 844. For example, the second control interface 844 can be implemented with a pressure sensor, an inertial sensor, a microelectromechanical system (MEMS), optical circuitry, waveguides, wireless circuitry, wireline circuitry, or a combination thereof.

A second storage unit 846 can store the second software 842. The second storage unit 846 can also store the relevant information, such as advertisements, points of interest (POI), navigation routing entries, or any combination thereof. The second storage unit 846 can be sized to provide the additional storage capacity to supplement the first storage unit 814.

For illustrative purposes, the second storage unit 846 is shown as a single element, although it is understood that the second storage unit 846 can be a distribution of storage elements. Also for illustrative purposes, the content delivery system 100 is shown with the second storage unit 846 as a single hierarchy storage system, although it is understood that the content delivery system 100 can have the second storage unit 846 in a different configuration. For example, the second storage unit 846 can be formed with different storage technologies forming a memory hierarchal system including different levels of caching, main memory, rotating media, or off-line storage.

The second storage unit 846 can be a volatile memory, a nonvolatile memory, an internal memory, an external memory, or a combination thereof. For example, the second storage unit 846 can be a nonvolatile storage such as non-volatile random access memory (NVRAM), Flash memory, disk storage, or a volatile storage such as static random access memory (SRAM).

The second storage unit 846 can include a second storage interface 848. The second storage interface 848 can be used for communication between the location unit 820 and other functional units in the second device 106. The second storage interface 848 can also be used for communication that is external to the second device 106.

The second storage interface 848 can receive information from the other functional units or from external sources, or can transmit information to the other functional units or to external destinations. The external sources and the external destinations refer to sources and destinations physically separate to the second device 106.

The second storage interface 848 can include different implementations depending on which functional units or external units are being interfaced with the second storage unit 846. The second storage interface 848 can be implemented with technologies and techniques similar to the implementation of the second control interface 844.

The second communication unit 836 can enable external communication to and from the second device 106. For example, the second communication unit 836 can permit the second device 106 to communicate with the first device 102 over the communication path 104.

The second communication unit 836 can also function as a communication hub allowing the second device 106 to function as part of the communication path 104 and not limited to be an end point or terminal unit to the communication path 104. The second communication unit 836 can include active and passive components, such as microelectronics or an antenna, for interaction with the communication path 104.

The second communication unit 836 can include a second communication interface 850. The second communication interface 850 can be used for communication between the second communication unit 836 and other functional units in the second device 106. The second communication interface 850 can receive information from the other functional units or can transmit information to the other functional units.

The second communication interface 850 can include different implementations depending on which functional units are being interfaced with the second communication unit 836. The second communication interface 850 can be implemented with technologies and techniques similar to the implementation of the second control interface 844.

The first communication unit 816 can couple with the communication path 104 to send information to the second device 106 in the first device transmission 808. The second device 106 can receive information in the second communication unit 836 from the first device transmission 808 of the communication path 104.

The second communication unit 836 can couple with the communication path 104 to send information to the first device 102 in the second device transmission 810. The first device 102 can receive information in the first communication unit 816 from the second device transmission 810 of the communication path 104. The content delivery system 100 can be executed by the first control unit 812, the second control unit 834, or a combination thereof.

For illustrative purposes, the second device 106 is shown with the partition having the second user interface 838, the second storage unit 846, the second control unit 834, and the second communication unit 836, although it is understood that the second device 106 can have a different partition. For example, the second software 842 can be partitioned differently such that some or all of its functions can be in the second control unit 834 and the second communication unit 836. Also, the second device 106 can include other functional units not shown in FIG. 8 for clarity.

The third device 108 can include a third control unit 852, a third storage unit 854, a third communication unit 856, a third user interface 858, and a location unit 860. The third control unit 852 can include a third control interface 862. The third control unit 852 can execute a third software 866 to provide the intelligence of the content delivery system 100. The third control unit 852 can be implemented in a number of different manners. For example, the third control unit 852 can be a processor, an embedded processor, a microprocessor, a hardware control logic, a hardware finite state machine (FSM), a digital signal processor (DSP), or a combination thereof. The third control interface 862 can be used for communication between the third control unit 852 and other functional units in the third device 108. The third control interface 862 can also be used for communication that is external to the third device 108.

The third control interface 862 can receive information from the other functional units or from external sources, or can transmit information to the other functional units or to external destinations. The external sources and the external destinations refer to sources and destinations physically separate to the third device 108.

The third control interface 862 can be implemented in different ways and can include different implementations depending on which functional units or external units are being interfaced with the third control interface 862. For example, the third control interface 862 can be implemented with a pressure sensor, an inertial sensor, a microelectromechanical system (MEMS), optical circuitry, waveguides, wireless circuitry, wireline circuitry, or a combination thereof.

The location unit 860 can generate location information, current heading, and current speed of the third device 108, as examples. The location unit 860 can be implemented in many ways. For example, the location unit 860 can function as at least a part of a global positioning system (GPS), an inertial navigation system, a cellular-tower location system, a pressure location system, or any combination thereof.

The location unit 860 can include a location interface 872. The location interface 872 can be used for communication between the location unit 860 and other functional units in the third device 108. The location interface 872 can also be used for communication that is external to the third device 108.

The location interface 872 can receive information from the other functional units or from external sources, or can transmit information to the other functional units or to external destinations. The external sources and the external destinations refer to sources and destinations physically separate to the third device 108.

The location interface 872 can include different implementations depending on which functional units or external units are being interfaced with the location unit 860. The location interface 872 can be implemented with technologies and techniques similar to the implementation of the third control interface 862.

The third storage unit 854 can store the third software 866. The third storage unit 854 can also store the relevant information, such as advertisements, points of interest (POI), navigation routing entries, or any combination thereof.

The third storage unit 854 can be a volatile memory, a nonvolatile memory, an internal memory, an external memory, or a combination thereof. For example, the third storage unit 854 can be a nonvolatile storage such as non-volatile random access memory (NVRAM), Flash memory, disk storage, or a volatile storage such as static random access memory (SRAM).

The third storage unit 854 can include a third storage interface 864. The third storage interface 864 can be used for communication between the location unit 860 and other functional units in the third device 108. The third storage interface 864 can also be used for communication that is external to the third device 108.

The third storage interface 864 can receive information from the other functional units or from external sources, or can transmit information to the other functional units or to external destinations. The external sources and the external destinations refer to sources and destinations physically separate to the third device 108.

The third storage interface 864 can include different implementations depending on which functional units or external units are being interfaced with the third storage unit 854. The third storage interface 864 can be implemented with technologies and techniques similar to the implementation of the third control interface 862.

The third communication unit 856 can enable external communication to and from the third device 108. For example, the third communication unit 856 can permit the third device 108 to communicate with the second device 106 of FIG. 1, an attachment, such as a peripheral device or a computer desktop, and the communication path 104.

The third communication unit 856 can also function as a communication hub allowing the third device 108 to function as part of the communication path 104 and not limited to be an end point or terminal unit to the communication path 104. The third communication unit 856 can include active and passive components, such as microelectronics or an antenna, for interaction with the communication path 104.

The third communication unit 856 can include a third communication interface 868. The third communication interface 868 can be used for communication between the third communication unit 856 and other functional units in the third device 108. The third communication interface 868 can receive information from the other functional units or can transmit information to the other functional units.

The third communication interface 868 can include different implementations depending on which functional units are being interfaced with the third communication unit 856. The third communication interface 868 can be implemented with technologies and techniques similar to the implementation of the third control interface 862.

The third user interface 858 allows a user (not shown) to interface and interact with the third device 108. The third user interface 858 can include an input device and an output device. Examples of the input device of the third user interface 858 can include a keypad, a touchpad, soft-keys, a keyboard, a microphone, or any combination thereof to provide data and communication inputs.

The third user interface 858 can include a third display interface 870. The third display interface 870 can include a display, a projector, a video screen, a speaker, or any combination thereof.

The third control unit 852 can operate the third user interface 858 to display information generated by the content delivery system 100. The third control unit 852 can also execute the third software 866 for the other functions of the content delivery system 100, including receiving location information from the location unit 860. The third control unit 852 can further execute the third software 866 for interaction with the communication path 104 via the third communication unit 856.

The fourth device 110 can include a fourth control unit 888, a fourth communication unit 874, and a fourth user interface 876. The fourth user interface 876 allows a user (not shown) to interface and interact with the fourth device 110. The fourth user interface 876 can include an input device and an output device. Examples of the input device of the fourth user interface 876 can include a keypad, a touchpad, soft-keys, a keyboard, a microphone, or any combination thereof to provide data and communication inputs. Examples of the output device of the fourth user interface 876 can include a fourth display interface 809. The fourth display interface 809 can include a display, a projector, a video screen, a speaker, or any combination thereof.

The fourth control unit 888 can execute a fourth software 878 to provide the intelligence of the fourth device 110 of the content delivery system 100. The fourth software 878 can operate in conjunction with the first software 826. The fourth control unit 888 can provide additional performance compared to the first control unit 812.

The fourth control unit 888 can operate the fourth user interface 876 to display information. The fourth control unit 888 can also execute the fourth software 878 for the other functions of the content delivery system 100, including operating the fourth communication unit 874 to communicate with the first device 102 over the communication path 104.

The fourth control unit 888 can be implemented in a number of different manners. For example, the fourth control unit 888 can be a processor, an embedded processor, a microprocessor, a hardware control logic, a hardware finite state machine (FSM), a digital signal processor (DSP), or a combination thereof.

The fourth control unit 888 can include a fourth controller interface 880. The fourth controller interface 880 can be used for communication between the fourth control unit 888 and other functional units in the fourth device 110. The fourth controller interface 880 can also be used for communication that is external to the fourth device 110.

The fourth controller interface 880 can receive information from the other functional units or from external sources, or can transmit information to the other functional units or to external destinations. The external sources and the external destinations refer to sources and destinations physically separate to the fourth device 110.

The fourth controller interface 880 can be implemented in different ways and can include different implementations depending on which functional units or external units are being interfaced with the fourth controller interface 880. For example, the fourth controller interface 880 can be implemented with a pressure sensor, an inertial sensor, a microelectromechanical system (MEMS), optical circuitry, waveguides, wireless circuitry, wireline circuitry, or a combination thereof.

A fourth storage unit 882 can store the fourth software 878. The fourth storage unit 882 can also store the relevant information, such as advertisements, points of interest (POI), navigation routing entries, or any combination thereof. The fourth storage unit 882 can be sized to provide the additional storage capacity to supplement the first storage unit 814.

For illustrative purposes, the fourth storage unit 882 is shown as a single element, although it is understood that the fourth storage unit 882 can be a distribution of storage elements. Also for illustrative purposes, the content delivery system 100 is shown with the fourth storage unit 882 as a single hierarchy storage system, although it is understood that the content delivery system 100 can have the fourth storage unit 882 in a different configuration. For example, the fourth storage unit 882 can be formed with different storage technologies forming a memory hierarchal system including different levels of caching, main memory, rotating media, or off-line storage.

The fourth storage unit 882 can be a volatile memory, a nonvolatile memory, an internal memory, an external memory, or a combination thereof. For example, the fourth storage unit 882 can be a nonvolatile storage such as non-volatile random access memory (NVRAM), Flash memory, disk storage, or a volatile storage such as static random access memory (SRAM).

The fourth storage unit 882 can include a fourth storage interface 884. The fourth storage interface 884 can be used for communication between the location unit 820 and other functional units in the fourth device 110. The fourth storage interface 884 can also be used for communication that is external to the fourth device 110.

The fourth storage interface 884 can receive information from the other functional units or from external sources, or can transmit information to the other functional units or to external destinations. The external sources and the external destinations refer to sources and destinations physically separate to the fourth device 110.

The fourth storage interface 884 can include different implementations depending on which functional units or external units are being interfaced with the fourth storage unit 882. The fourth storage interface 884 can be implemented with technologies and techniques similar to the implementation of the fourth controller interface 880.

The fourth communication unit 874 can enable external communication to and from the fourth device 110. For example, the fourth communication unit 874 can permit the fourth device 110 to communicate with the first device 102 over the communication path 104.

The fourth communication unit 874 can also function as a communication hub allowing the fourth device 110 to function as part of the communication path 104 and not limited to be an end point or terminal unit to the communication path 104. The fourth communication unit 874 can include active and passive components, such as microelectronics or an antenna, for interaction with the communication path 104.

The fourth communication unit 874 can include a fourth communication interface 886. The fourth communication interface 886 can be used for communication between the fourth communication unit 874 and other functional units in the fourth device 110. The fourth communication interface 886 can receive information from the other functional units or can transmit information to the other functional units.

The fourth communication interface 886 can include different implementations depending on which functional units are being interfaced with the fourth communication unit 874. The fourth communication interface 886 can be implemented with technologies and techniques similar to the implementation of the fourth controller interface 880.

The first communication unit 816 can couple with the communication path 104 to send information to the fourth device 110 in the first device transmission 808. The fourth device 110 can receive information in the fourth communication unit 874 from the first device transmission 808 of the communication path 104.

The fourth communication unit 874 can couple with the communication path 104 to send information to the first device 102 in the fourth device transmission 810. The first device 102 can receive information in the first communication unit 816 from the fourth device transmission 810 of the communication path 104. The content delivery system 100 can be executed by the first control unit 812, the fourth control unit 888, or a combination thereof.

For illustrative purposes, the fourth device 110 is shown with the partition having the fourth user interface 876, the fourth storage unit 882, the fourth control unit 888, and the fourth communication unit 874, although it is understood that the fourth device 110 can have a different partition. For example, the fourth software 878 can be partitioned differently such that some or all of its functions can be in the fourth control unit 888 and the fourth communication unit 874. Also, the fourth device 110 can include other functional units not shown in FIG. 8 for clarity.

The fifth device 112 can include a fifth control unit 890, a fifth communication unit 892, and a fifth user interface 894. The fifth user interface 894 allows a user (not shown) to interface and interact with the fifth device 112. The fifth user interface 894 can include an input device and an output device. Examples of the input device of the fifth user interface 894 can include a keypad, a touchpad, soft-keys, a keyboard, a microphone, or any combination thereof to provide data and communication inputs. Examples of the output device of the fifth user interface 894 can include a fifth display interface 896. The fifth display interface 896 can include a display, a projector, a video screen, a speaker, or any combination thereof.

The fifth control unit 890 can execute a fifth software 898 to provide the intelligence of the fifth device 112 of the content delivery system 100. The fifth software 898 can operate in conjunction with the first software 826. The fifth control unit 890 can provide additional performance compared to the first control unit 812.

The fifth control unit 890 can operate the fifth user interface 894 to display information. The fifth control unit 890 can also execute the fifth software 898 for the other functions of the content delivery system 100, including operating the fifth communication unit 892 to communicate with the first device 102 over the communication path 104.

The fifth control unit 890 can be implemented in a number of different manners. For example, the fifth control unit 890 can be a processor, an embedded processor, a microprocessor, a hardware control logic, a hardware finite state machine (FSM), a digital signal processor (DSP), or a combination thereof.

The fifth control unit 890 can include a fifth controller interface 801. The fifth controller interface 801 can be used for communication between the fifth control unit 890 and other functional units in the fifth device 112. The fifth controller interface 801 can also be used for communication that is external to the fifth device 112.

The fifth controller interface 801 can receive information from the other functional units or from external sources, or can transmit information to the other functional units or to external destinations. The external sources and the external destinations refer to sources and destinations physically separate to the fifth device 112.

The fifth controller interface 801 can be implemented in different ways and can include different implementations depending on which functional units or external units are being interfaced with the fifth controller interface 801. For example, the fifth controller interface 801 can be implemented with a pressure sensor, an inertial sensor, a microelectromechanical system (MEMS), optical circuitry, waveguides, wireless circuitry, wireline circuitry, or a combination thereof.

A fifth storage unit 803 can store the fifth software 898. The fifth storage unit 803 can also store the relevant information, such as advertisements, points of interest (POI), navigation routing entries, or any combination thereof. The fifth storage unit 803 can be sized to provide the additional storage capacity to supplement the first storage unit 814.

For illustrative purposes, the fifth storage unit 803 is shown as a single element, although it is understood that the fifth storage unit 803 can be a distribution of storage elements. Also for illustrative purposes, the content delivery system 100 is shown with the fifth storage unit 803 as a single hierarchy storage system, although it is understood that the content delivery system 100 can have the fifth storage unit 803 in a different configuration. For example, the fifth storage unit 803 can be formed with different storage technologies forming a memory hierarchal system including different levels of caching, main memory, rotating media, or off-line storage.

The fifth storage unit 803 can be a volatile memory, a nonvolatile memory, an internal memory, an external memory, or a combination thereof. For example, the fifth storage unit 803 can be a nonvolatile storage such as non-volatile random access memory (NVRAM), Flash memory, disk storage, or a volatile storage such as static random access memory (SRAM).

The fifth storage unit 803 can include a fifth storage interface 805. The fifth storage interface 805 can be used for communication between the location unit 820 and other functional units in the fifth device 112. The fifth storage interface 805 can also be used for communication that is external to the fifth device 112.

The fifth storage interface 805 can receive information from the other functional units or from external sources, or can transmit information to the other functional units or to external destinations. The external sources and the external destinations refer to sources and destinations physically separate to the fifth device 112.

The fifth storage interface 805 can include different implementations depending on which functional units or external units are being interfaced with the fifth storage unit 803. The fifth storage interface 805 can be implemented with technologies and techniques similar to the implementation of the fifth controller interface 801.

The fifth communication unit 892 can enable external communication to and from the fifth device 112. For example, the fifth communication unit 892 can permit the fifth device 112 to communicate with the first device 102 over the communication path 104.

The fifth communication unit 892 can also function as a communication hub allowing the fifth device 112 to function as part of the communication path 104 and not limited to be an end point or terminal unit to the communication path 104. The fifth communication unit 892 can include active and passive components, such as microelectronics or an antenna, for interaction with the communication path 104.

The fifth communication unit 892 can include a fifth communication interface 807. The fifth communication interface 807 can be used for communication between the fifth communication unit 892 and other functional units in the fifth device 112. The fifth communication interface 807 can receive information from the other functional units or can transmit information to the other functional units.

The fifth communication interface 807 can include different implementations depending on which functional units are being interfaced with the fifth communication unit 892. The fifth communication interface 807 can be implemented with technologies and techniques similar to the implementation of the fifth controller interface 801.

The first communication unit 816 can couple with the communication path 104 to send information to the fifth device 112 in the first device transmission 808. The fifth device 112 can receive information in the fifth communication unit 892 from the first device transmission 808 of the communication path 104.

The fifth communication unit 892 can couple with the communication path 104 to send information to the first device 102 in the fifth device transmission 810. The first device 102 can receive information in the first communication unit 816 from the fifth device transmission 810 of the communication path 104. The content delivery system 100 can be executed by the first control unit 812, the fifth control unit 890, or a combination thereof.

For illustrative purposes, the fifth device 112 is shown with the partition having the fifth user interface 894, the fifth storage unit 803, the fifth control unit 890, and the fifth communication unit 892, although it is understood that the fifth device 112 can have a different partition. For example, the fifth software 898 can be partitioned differently such that some or all of its functions can be in the fifth control unit 890 and the fifth communication unit 892. Also, the fifth device 112 can include other functional units not shown in FIG. 8 for clarity.

The functional units in the first device 102 can work individually and independently of the other functional units. The first device 102 can work individually and independently from the second device 106, the third device 108, the fourth device 110, the fifth device 112, and the communication path 104.

The functional units in the second device 106 can work individually and independently of the other functional units. The second device 106 can work individually and independently from the first device 102, the third device 108, the fourth device 110, the fifth device 112, and the communication path 104.

The functional units in the third device 108 can work individually and independently of the other functional units. The third device 108 can work individually and independently from the first device 102, the second device 106, the fourth device 110, the fifth device 112, and the communication path 104.

The functional units in the fourth device 110 can work individually and independently of the other functional units. The fourth device 110 can work individually and independently from the first device 102, the second device 106, the third device 108, the fifth device 112, and the communication path 104.

The functional units in the fifth device 112 can work individually and independently of the other functional units. The fifth device 112 can work individually and independently from the first device 102, the second device 106, the third device 108, the fourth device 110, and the communication path 104.

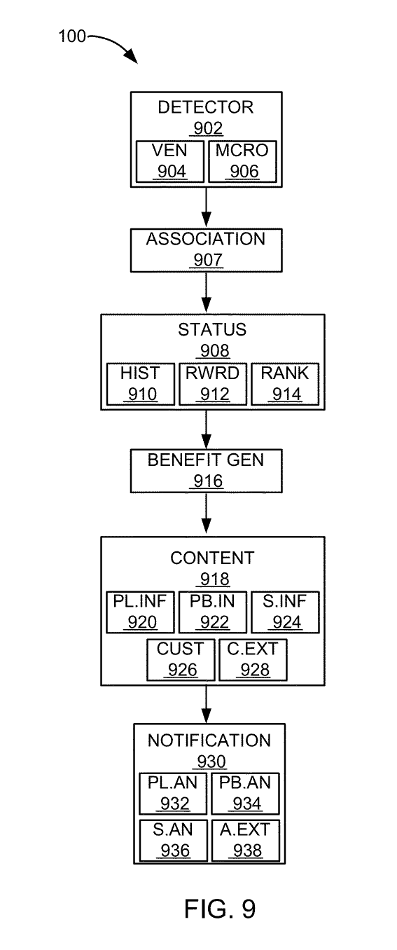

Referring now to FIG. 9, therein shown is a control flow of the content delivery system 100. The content delivery system 100 can include a detector module 902. The detector module 902 detects the target user's presence within the venue 204 of FIG. 2. For example, the detector module 902 can detect the target user's location 202 of FIG. 2 for identifying the target user's location 202 within the venue 204.

The detector module 902 can detect the target user's location 202 in a number of ways. The detector module 902 includes a venue module 904. The venue module 904 detects whether the target user's location 202, the venue co-participant's location 216 of FIG. 2, or a combination thereof is within the venue 204.

The venue module 904 can establish a geographic boundary for determining whether the target user's location 202, the venue co-participant's location 216, or a combination thereof is within the venue 204. For example, the venue module 904 can establish the shopping area of Fry's as the venue 204. For another example, the venue module 904 can establish the geographic area within the borderline of the city as the venue 204.

The venue module 904 can detect the target user's location 202 based on the location information generated by the location unit 820 of FIG. 8. More specifically, the venue module 904 can detect whether the location information of the target user's location 202 is inside or outside of the geographic boundary of the venue 204. The venue module 904 can also detect the venue co-participant's location 216 based on the location information provided by the location unit 860 of FIG. 8 similarly to detecting the target user's location 202.

The detector module 902 includes a micro-locator module 906. The micro-locator module 906 detects whether the target user's location 202, the venue co-participant's location 216, or a combination thereof is within the section 206 of FIG. 2 of the venue 204. For example, the micro-locator module 906 can detect the target user's location 202 at the section 206 representing a produce section within the grocery store based on the location information generated by the location unit 820.

The micro-locator module 906 can obtain map information related to the section 206 of the venue 204 from the external sources via the first control interface 822 of FIG. 8. For example, the micro-locator module 906 can obtain the shopping mall directory and the floor map of all the stores within the shopping mall.

The micro-locator module 906 can detect the target user's location 202 based on the GPS signal, the WiFi signal, the NFC signal, or a combination thereof. For specific example, the micro-locator module 906 can detect the NFC signal unique to the section 206. The location unit 820 can generate the location information to determine that the target user's location 202 is within the section 206 representing a produce section of the grocery store by detecting the NFC signal unique to the produce section. The micro-locator module 906 can detect the venue co-participant's location 216 similarly as the target user's location 202.

The content delivery system 100 can include an association module 907, which can be coupled to the detector module 902. The association module 907 determines the venue association 207 of FIG. 2. For example, the association module 207 can determine the venue association 207 based on the target user's location 202 for identifying the venue 204.

For example, the target user's location 202 can indicate that the target user is in San Jose, Calif. For specific example, the venue 204 can be Fry's. More specifically, the association module 907 can obtain the address information for the venue 204 from the external sources via the first control interface 822. Further, the association module 907 can obtain the business information for Fry's from the external sources via the first control interface 822. Based on the information obtained and the target user's location 202, the association module 907 can determine the venue association 207 of the venue 204 to be the San Jose store for Fry's.

The content delivery system 100 can include a status module 908, which can be coupled to the association module 907. The status module 908 determines the target user's status 222 of FIG. 2. For example, the status module 908 can determine the target user's status 222 based on the target user's location 202 for identifying the target user's status 222 within the venue 204.

The status module 908 can determine the target user's status 222 in a number of ways. The status module 908 includes a history module 910. The history module 910 tracks the activity history of the target user, the venue co-participant, or a combination thereof within the venue 204. For example, the history module 910 can track the number of visits by the target user to the venue 204, the purchase history at the venue 204, the purchase style of the target user at the venue 204, or a combination thereof. The purchase style can include whether the target user had used coupons, used reward points, or a combination thereof for purchasing the product, the service, or a combination thereof within the venue 204. The history module 910 can track the activity history within the venue 204 of the target user, the venue co-participant, or a combination thereof.

The status module 908 includes a reward module 912. The reward module 912 tracks the reward points, the scores, or a combination thereof accumulated by the target user, the venue co-participant, or a combination thereof based on the activity within the venue 204. As discussed previously, the reward module 912 can add reward points if the target user purchased a product within the venue 204.

The status module 908 includes a rank module 914. The rank module 914 tracks the target user's status 222, the venue co-participant's status 224 of FIG. 2, or a combination thereof within the venue 204. For example, the rank module 914 can determine the target user's status 222 based on the target user's location 202 for identifying the target user's status 222 within the venue 204.

For example, the rank module 914 can track the target user's status 222, the venue co-participant's status 224, or a combination thereof in a number of ways. For specific example, the target user's status 222 relative to the venue co-participant's status 224 can base on the reward points accumulated by the target user for the venue 204. Further, based on the reward points accumulated, the target user can be ranked in a sequential order from the highest point accumulator to the lowest point accumulator with the higher point accumulator as the higher rank within the venue 204. For another example, the rank module 914 can anoint level, such as “Level 5,” or title, such as “Top Saver,” as illustrated in FIG. 6, based on the reward points, the scores, or a combination thereof accumulated.

For another example, the rank module 914 can determine the target user's status 222 based on the section 206 of the venue 204. For specific example, the reward points, the score, or a combination thereof can be accumulated based on the section 206. More specifically, the target user's status 222 for the laptop section at Fry's can be “Top Saver” while the target user's status 222 for the entertainment section can be “Average Saver.”

For different example, the rank module 914 can determine the target user's status 222 based on the venue association 207 for identifying the target user's status 222 within the venue 204. The target user can accumulate the reward points for the San Jose branch of Fry's. However, the target user can seldom shop at the Fremont branch of Fry's. The rank module 914 can determine the target user's status 222 at the San Jose branch of Fry's as a premium shopper while the rank module 914 can determine the target user's status at the Fremont branch of Fry's as an average shopper. The rank module 914 can determine that the target user's status 222 to have a higher ranking for the venue 204 associated with the venue association 207 of the San Jose branch.

It has been discovered that the present invention can determine the target user's status 222 that is association specific based on the venue association 207 for enhancing the user experience at a plurality of the venue 204. By tracking the target user's status 222 for each of the plurality of the venue 204 sharing the venue association 207, the content delivery system 100 can generate the target user's content 208 of FIG. 2 tailored for each of the plurality of the venue 204. The target user's content 208 can include savings discount to reduce the financial burden for shopping at the venue 204. As a result, the target user can enhance the target user experience of using the content delivery system 100 and visiting the venue 204 by increasing the opportunity to purchase products and services at the venue 204 at a lower price.

The content delivery system 100 can include a benefit generator module 916, which can be coupled to the status module 908. The benefit generator module 916 generates the benefit available for the target user, the venue co-participant, or a combination thereof within the venue 204. For example, the benefit generator module 916 can generate the discount for making a purchase, the access of service or product within the venue 204, the notoriety within the venue 204, or a combination thereof based on the target user's status 222, the venue co-participant's status 224, or a combination thereof.

The content delivery system 100 can include a content module 918, which can be coupled to the benefit generator module 916. The content module 918 generates the content that can be displayed on the devices. For example, the content module 918 can generate the target user's content 208 based on the target user's status 222 for displaying on the target user's device 210 of FIG. 2.

The content module 918 can generate the content in a number of ways. The content module 918 includes a personal information module 920. The personal information module 920 can generate the target user's content 208 based on the target user's status 222 for displaying on the target user's device 210. For example, the personal information module 920 can generate the benefit preview 402 of FIG. 4 based on the target user's status 222 for displaying on the target user's device 210.

For specific example, the personal information module 920 can generate the benefit preview 402 based on the benefit generated by the benefit generator module 916. More specifically, the benefit preview 402 can include the discounted price of the product when the reward points are applied to the original price. Further, the benefit preview 402 can include the activity required by the target user to take advantage of the discounted price. For example, the benefit preview 402 can include the amount of the reward point further required by the target user to take advantage of the discounted price.

It has been discovered that the present invention can generate the benefit preview 402 to enhance the user experience of using the content delivery system 100, visiting the venue 204, or a combination thereof. By having the benefit preview 402 as part of the target user's content 208, the content delivery system 100 can motivate the target user to increase the activity within the venue 204. Moreover, the motivation can enhance the target user's target user experience by showing the benefit available in the near future at the venue 204. The benefit can include savings discount to reduce the financial burden for shopping at the venue 204. As a result, the benefit preview 402 can enhance the target user experience by setting an achievable goal for the target user to enjoy visiting the venue 204. Furthermore, the benefit preview 402 can aid the target user to plan for future purchases to save time and money from purchasing the product or service available in the venue 204.

For another example, the personal information module 920 can generate the target user's content 208 available only to the target user but unavailable to the public. For example, the target user's content 208 can include a personal greeting welcoming the target user to the venue 204. For different example, the target user's content 208 can include the total amount of the reward points accumulated by the target user. For further example, the target user's content can include the benefit tailored specifically to the target user but unavailable to the venue co-participant. More specifically, the target user's content 208 can include a special deal for the target user who had been a loyal customer to the venue 204.

For different example, the personal information module 920 can generate the target user's content 208 specific for the section 206 within the venue 204. More specifically, once the detector module 902 detected the target user's location 202 within the section 206, the personal information module 920 can generate the target user's content 208 specific to the section 206.

The content module 918 can include a public information module 922. The public information module 922 can generate the public content 218 of FIG. 2 based on the target user's status 222, the public content 218 different from the target user's content 208, for displaying on the public device 220 of FIG. 2 within the venue 204.

For example, the public content 218 can include information related to the target user's status 222 that can be public. For specific example, the target user's rank within the venue 204 can be shared, thus, be included in the public content 218. For different example, the public content 218 can include the target user's location 202, the venue co-participant's location 216, or a combination thereof.

For another example, the public information module 922 can generate the public content 218 based on the target user's status 222 within the venue 204 for displaying on the venue co-participant's device 214 of FIG. 2. For specific example, as illustrated in FIG. 5, information related to the target user's status 222 can be displayed on the venue co-participant's device 214. The public content 218 can include the benefit received by the target user, the venue co-participant, or a combination thereof.

For different example, the public information module 922 can generate the public content 218 for the image of the product available within the venue 204 with the overlay of the price of the product as an augmented reality. The overlay of the price can be viewed as the signage on the product, the service, or a combination thereof. For further example, the augmented reality view can include the image of the signage to be displayed on the target user's device 210, the venue co-participant's device 214, the public device 220, or a combination thereof.

The content module 918 can include a service information module 924. The service information module 924 generates the service content 226 of FIG. 2. For example, the service information module 924 can generate the service content 226 based on the target user's status 222 for displaying on the service device 228.

For specific example, the venue 204 can represent Fry's as illustrated in FIG. 8. The target user's status 222 can include the activity history of the target user shopping at Fry's. The service content 226 can include the number of visits by the target user to the venue 204, the purchase history at the venue 204, the purchase style of the target user at the venue 204, or a combination thereof.

For another example, the service content 226 can include the target user's potential future activity and the recommendation. The service information module 924 can extrapolate the target user's potential future activity based on the target user's activity history. More specifically, the target user can buy Samsung Galaxy™ as a new smart phone. The service information module 924 can recommend a headset compatible with the Samsung Galaxy™.

For different example, the service content 226 can include the target user's profile to better serve the target user by the official representative of the venue 204. For example, if the venue 204 represents a clothing store, the service content 226 can include the shirt size, shirt style, pants size, or a combination thereof for the employee to understand what the target user might purchase next.

The content module 918 can include a customization module 926. The customization module 926 allows customization of the information made available to the target user, the venue co-participant, the public, or a combination thereof. For example, the customization module 926 can generate the target user's content 208 customized for displaying on the public device 220, the venue co-participant's device 214, or a combination thereof.

The customization module 926 can customize the target user's content 208. The customization module 926 customizes the target user's content 208 based on the target user's activity within the venue 204. For example, the content delivery system 100 can transmit the coupon for a paper shredder machine on the target user's device 210. The target user can ignore the coupon because the target user is uninterested in the paper shredder machine. However, the target user can select the coupon for the new mobile phone. Subsequently, the customization module 926 can generate the coupon related to the mobile phone for the target user's device 210 more frequently and less frequently for the coupon related to the paper shredder machine. The customization module 926 can customize the venue co-participant's content 212 based on the venue co-participant's activity similarly as to the customization of the target user's content. The customization module 926 can customize the public content 218 similarly as to the customization of the target user's content 208 and the venue co-participant's content 212.

The content module 918 can include a content extrapolator module 928. The content extrapolator module 928 extrapolates the content interested by the target user, the venue co-participant, or a combination thereof. For example, the content extrapolator module 928 can extrapolate the target user's content 208 based on the target user's status 222 for displaying on the target user's device 210.

The content extrapolator module 928 can extrapolate the target user's content 208 based on the target user's activity history. For example, the content extrapolator module 928 can extrapolate the target user's content 208 that induced most responses by the target user. For specific example, the target user can respond to the target user's content 208 representing a video clip of an advertisement of the product more frequently than the target user's content representing a coupon. Subsequently, the content extrapolator module 928 can extrapolate the target user's content 208 preferred by the target user to be a video clip of the product rather than the coupon.

The content extrapolator module 928 can extrapolate the venue co-participant's content 212 preferred by the venue co-participant similarly to the extrapolation of the target user's content 208. The content extrapolator module 928 can extrapolate the public content 218 similarly to the extrapolation of the target user's content 208 and the venue co-participant's content 212.

For illustrative purposes, the content delivery system 100 is shown with the personal information module 920 generating the target user's content 208, although it is understood that the personal information module 920 can be operated differently. For example, the personal information module 920 can update the target user's content 208 based on the venue co-participant's status 224 within the venue.

For specific example, the venue co-participant's status 224 can become a higher rank than the target user's status 222. Subsequently, the benefit preview 402 can change as the benefit preview 402 can no longer show the benefit only available to the top rank target user within the venue 204.

For illustrative purposes, the content delivery system 100 is shown with the public information module 922 generating the public content 218, although it is understood that the public information module 922 can be operated differently. For example, the public information module 922 can update the public content 218 based on the target user's status 222.

For specific example, as illustrated above, the target user's status can drop in ranking as the venue co-participant can surpass the target user in the ranking Subsequently, the public content 218 can be updated to reflect the new ranking within the venue 204. The public information module 922 can update the venue co-participant's content 212 based on the target user's status 222 for displaying on the venue co-participant's device 214 similarly to the updating of the public content 218.

The content delivery system 100 can include a notification module 930, which can be coupled to the content module 918. The notification module 930 notifies the content to the target user, the venue co-participant, the public, or a combination thereof.

The notification module 930 can notify in a number of ways. The notification module 930 includes a personal announcement module 932. The personal announcement module 932 can display the target user's content 208 to the target user's device 210 when detecting the target user's location 202 is within the venue 204. For another example, the personal announcement module 932 can play the target user's favorite song when detecting the target user's location 202 is within the venue 204.

The notification module 930 includes a public announcement module 934 and a service announcement module 936. The public announcement module 934 can notify the venue co-participant's device 214, the public device 220, or a combination thereof similarly for notifying the target user's device 210.

For different example, the public announcement module 934 can prioritize the target user's device 210 over the venue co-participant's device 214, the public device 220, or a combination thereof based on the target user's status 222 for displaying the public content 218 on the target user's device 210. More specifically, the target user can choose not to display the information related to the target user's status 222 on the public device 220. Moreover, the target user can choose to only show the public content 218 on the target user's device 210. Subsequently, the public content 220 related to the target user can be displayed only on the target user's device 210.

The service announcement module 936 can notify the service device 228 similarly for notifying the target user's device 210. The service announcement module 936 can also prioritize the display of the information related to the target user's status 222 similarly to the public information module 934 prioritizing the target user's device 210 for displaying the information related to the target user's status 222.

The notification module 930 includes an announcement extrapolator module 938. The announcement extrapolator module 938 can extrapolate a timing of when to transmit the target user's content 208, the venue co-participant's content 212, the public content 218, or a combination thereof to the respective devices. For example, the activity history of the target user shows that the target user was more inclined to purchase the good if the target user discovered that the venue co-participant had gained closer in ranking to the target user. The announcement extrapolator module 938 can extrapolate that the target user's content 208 should be transmitted to the target user's device 210 as soon as if the venue co-participant's status 224 gains closer in ranking to the target user's ranking.

The physical transformation for entering the venue 204 results in movement in the physical world, such as people using the first device 102, the third device 108, or a combination thereof, based on the operation of the content delivery system 100. As the movement in the physical world occurs, the movement itself creates additional information that is converted back into the target user's content 208, the venue co-participant's content 212, the public content 218, the service content 226, or a combination thereof for the continued operation of the content delivery system 100 and to continue the movement in the physical world.

The first software 826 of FIG. 8 of the first device 102 of FIG. 8 can include the content delivery system 100. For example, the first software 826 can include the detector module 902, the association module 907, the status module 908, the benefit generator module 916, the content module 918, and the notification module 930.

The first control unit 812 of FIG. 8 can execute the first software 826 for the detector module 902 to detect the target user's location 202, the venue co-participant's location 216, or a combination thereof. The first control unit 812 can execute the first software 826 for association module 907 to determine the venue association 207. The first control unit 812 can execute the first software 826 for the status module 908 to determine the target user's status 222, the venue co-participant's status 224, or a combination thereof.

The first control unit 812 can execute the first software 826 for the benefit generator module 916 to generate the benefit. The first control unit 812 can execute the first software 826 for the content module 918 to generate the target user's content 208, the public content 218, the service content 226, or a combination thereof. The first control unit 812 can execute the first software 826 for the notification module to display the target user's content 208, the public content 218, the service content 226, or a combination thereof.

The second software 842 of FIG. 8 of the second device 106 of FIG. 8 can include the content delivery system 100. For example, the second software 842 can include the detector module 902, the association module 907, the status module 908, the benefit generator module 916, the content module 918, and the notification module 930.

The second control unit 834 of FIG. 8 can execute the second software 842 for the detector module 902 to detect the target user's location 202, the venue co-participant's location 216, or a combination thereof. The second control unit 834 can execute the second software 842 for the association module 907 to determine the venue association 207. The second control unit 834 can execute the second software 842 for the status module 908 to determine the target user's status 222, the venue co-participant's status 224, or a combination thereof.

The second control unit 834 can execute the second software 842 for the benefit generator module 916 to generate the benefit. The second control unit 834 can execute the second software 842 for the content module 918 to generate the target user's content 208, the public content 218, the service content 226, or a combination thereof. The second control unit 834 can execute the second software 842 for the notification module to display the target user's content 208, the public content 218, the service content 226, or a combination thereof.

The content delivery system 100 can be partitioned between the first software 826 and the second software 842. For example, the second software 842 can include the association module 907, the status module 908, the benefit generator module 916, the content module 918, and the notification module 930. The second control unit 834 can execute modules partitioned on the second software 842 as previously described.

The first software 826 can include the detector module 902. Based on the size of the first storage unit 814 of FIG. 8, the first software 826 can include additional modules of the content delivery system 100. The first control unit 812 can execute the modules partitioned on the first software 826 as previously described.

The first control unit 812 can operate the first communication unit 816 of FIG. 8 to send the target user's location 202 to the second device 106. The first control unit 812 can operate the first software 826 to operate the location unit 820 of FIG. 8. The second communication unit 836 of FIG. 8 can send the target user's content 208 to the first device 102 through the communication path 104 of FIG. 8.

It has been discovered that the present invention provides the content delivery system 100 for enhancing the target user experience by generating the target user's content 208, the venue co-participant's content 212, or the public content 218 based on the target user's location 202, the venue co-participant's location 216, or a combination thereof within the venue 204. By impacting what kind of the target user's content 208 to be displayed on the target user's device 210 triggered by the other people's presence at the venue 204, the content delivery system 100 can increase interaction between the target user and the venue 204. The target user's content 208 can include savings discount to reduce the financial burden for shopping at the venue 204. Further, by displaying the target user's status 222 as part of the public content 218 on the public device 220, the target user experience at the venue 204 can enhance, as the target user can gain notoriety within the venue 204. As a result, the content delivery system 100 can enhance the target user experience by increasing interaction between the target user with the venue co-participant, the venue 204, or a combination thereof.

The content delivery system 100 describes the module functions or order as an example. The modules can be partitioned differently. For example, the benefit generator module 916 and the content module 918 can be combined. Each of the modules can operate individually and independently of the other modules.

Furthermore, data generated in one module can be used by another module without being directly coupled to each other. For example, the content module 918 can receive the target user's status 222 from the status module 908. The detector module 902, the association module 907, the status module 908, the benefit generator module 916, the content module 918, and the notification module 930 can be implement in as hardware (not shown) within the first control unit 812, the second control unit 834, or special hardware (not shown) in the first device 102 or the second device 106.

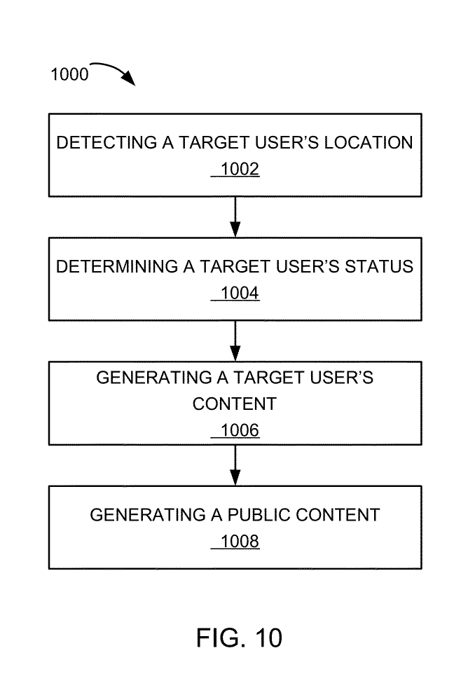

Referring now to FIG. 10, therein is shown a flow chart of a method 1000 of operation of the content delivery system 100 of FIG. 1 in a further embodiment of the present invention. The method 1000 includes: detecting a target user's location for identifying the target user's location within a venue in a block 1002; determining a target user's status based on the target user's location for identifying the target user's status within the venue in a block 1004; generating a target user's content based on the target user's status in a block 1006; and generating a public content based on the target user's status, the public content different from the target user's content, for displaying on a device within the venue in a block 1008.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a content delivery system comprising:
detecting a target user's location for identifying the target user's location within a venue;
determining a target user's status based on the target user's location for identifying the target user's status within the venue;
generating a target user's content based on the target user's status; and
generating a public content based on the target user's status, the public content different from the target user's content, for displaying on a device within the venue.

2. The method as claimed in claim 1 wherein generating the public content includes generating the public content based on the target user's status for displaying on a public device.

3. The method as claimed in claim 1 wherein generating the target user's content includes generating a benefit preview based on the target user's status for displaying on a target user's device.

4. The method as claimed in claim 1 further comprising generating a service content based on the target user's status for displaying on a service device.

5. The method as claimed in claim 1 further comprising updating the target user's content based on a venue co-participant's status for displaying on a target user's device.

6. A method of operation of a content delivery system comprising:
detecting a target user's location for identifying the target user's location within a venue;
determining a venue association based on the target user's location for identifying the venue;
determining a target user's status based on the venue association for identifying the target user's status within the venue;
generating a target user's content based on the target user's status; and
generating a public content based on the target user's status, the public content different from the target user's content, for displaying on a device within the venue.

7. The method as claimed in claim 6 wherein generating the target user's content includes extrapolating the target user's content based on the target user's status.

8. The method as claimed in claim 6 wherein generating the target user's content includes customizing the target user's content for displaying on a public device.

9. The method as claimed in claim 6 further comprising updating a venue co-participant's content based on the target user's status for displaying on a venue co-participant's device.

10. The method as claimed in claim 6 wherein generating the target user's content includes generating the target user's content for displaying the target user's content for a section of the venue.

11. A content delivery system comprising:
a detector module for detecting a target user's location within a venue;
a status module, coupled to the detector module, for determining a target user's status based on the target user's location for identifying the target user's status within the venue;
a personal information module, coupled to the status module, for generating a target user's content based on the target user's status; and
a public information module, coupled to the personal information module, for generating a public content based on the target user's status, the public content different from the target user's content, for displaying on a device within the venue.

12. The system as claimed in claim 11 wherein the public information module is for generating the public content based on the target user's status for displaying on a public device.

13. The system as claimed in claim 11 wherein the personal information module is for generating a benefit preview based on the target user's status for displaying on a target user's device.

14. The system as claimed in claim 11 further comprising a service information module, coupled to the status module, for generating a service content based on the target user's status for displaying on a service device.

15. The system as claimed in claim 11 wherein the personal information module is for updating the target user's content based on a venue co-participant's status within the venue for displaying on a target user's device.

16. The system as claimed in claim 11 further comprising:
an association module, coupled to the detector module, for determining a venue association based on the target user's location for identifying the venue; and
wherein:
the status module is for determining a target user's status based on the venue association for identifying the target user's status within the venue.

17. The system as claimed in claim 16 further comprising a content extrapolator module, coupled to the status module, for extrapolating the target user's content based on the target user's status.

18. The system as claimed in claim 16 further comprising a customization module, coupled to the status module, for customizing the target user's content for displaying on a public device.

19. The system as claimed in claim 16 wherein the public information module is for updating a venue co-participant's content based on the target user's status for displaying on a venue co-participant's device.

20. The system as claimed in claim 16 wherein the personal information module is for generating the target user's content for displaying the target user's content for a section of the venue.
